(19) United States
(12) Patent Application Publication
(10) Pub. No.: US 2023/0391145 A1
(43) Pub. Date: Dec. 7, 2023

(54) PNEUMATIC TIRE

(71) Applicant: The Yokohama Rubber Co., Ltd., Tokyo (JP)

(72) Inventors: Masahiro NARUSE, Kanagawa (JP); Masato TADOKORO, Kanagawa (JP)

(21) Appl. No.: 18/250,316

(22) PCT Filed: Oct. 18, 2021
(86) PCT No.: PCT/JP2021/038406

§ 371 Date: Apr. 24, 2023

(30) Foreign Application Priority Data
Oct. 29, 2020 (JP) 2020-181040

(51) Int. Cl. B60C 19/00; H01Q 15/00

(52) U.S. Cl. CPC B60C 19/00; H01Q 15/0013

(57) ABSTRACT

In a pneumatic tire including a tread portion extending in a tire circumferential direction and having an annular shape, a pair of sidewall portions respectively disposed on both sides of the tread portion, a pair of bead portions each disposed on an inner side of the pair of sidewall portions in a tire radial direction, and a transponder embedded, a composite sheet that includes a dielectric forming a substrate and a conductor periodically disposed on the dielectric and functions as an artificial magnetic conductor is disposed on an inner side in a tire width direction of the transponder.

### TECHNICAL FIELD

The present technology relates to a pneumatic tire with a transponder embedded and relates particularly to a pneumatic tire that can provide improved communication performance of the transponder.

### BACKGROUND ART

For pneumatic tires, embedding an RFID (radio frequency identification) tag (transponder) in a tire has been proposed (see, for example, Japan Unexamined Patent Publication No. H07-137510 A). Such a transponder radiates radio waves during communication with a reader/writer, and as illustrated in FIG. 12, the radio waves include a radio wave radiated from a transponder T toward the tire outer side (front wave Wa) and a radio wave radiated from the transponder T toward the tire inner side (back wave Wb). When a metal tire component M (for example, a chafer or a steel carcass) is present around the transponder T embedded in the tire, a phase of the back wave Wb of the transponder T is inverted (rotated by 180°) when the back wave Wb is reflected by the metal tire component M, and the phases of the reflected back wave Wc and the front wave Wa are opposite, and thus the front wave Wa and the back wave Wc counteract each other. This degrades the communication performance of the transponder.

### SUMMARY

The present technology provides a pneumatic tire that can provide improved communication performance of a transponder.

A pneumatic tire according to an embodiment of the present technology includes a tread portion extending in a tire circumferential direction and having an annular shape, a pair of sidewall portions respectively disposed on both sides of the tread portion, a pair of bead portions each disposed on an inner side of the pair of sidewall portions in a tire radial direction, and a transponder embedded. In the pneumatic tire, a composite sheet that includes a dielectric forming a substrate and a conductor periodically disposed on the dielectric and functions as an artificial magnetic conductor is disposed on an inner side in a tire width direction of the transponder.

In a pneumatic tire according to an embodiment of the present technology in which the transponder is embedded, the composite sheet that includes the dielectric forming the substrate and the conductor periodically disposed on the dielectric and functions as an artificial magnetic conductor is disposed on the inner side in the tire width direction of the transponder. The artificial magnetic conductor typically adjusts the reflection phase of the electromagnetic wave inverted (rotated by 180°) on the conductor to the same phase. The composite sheet functioning as the artificial magnetic conductor is disposed on the inner side in the tire width direction of the transponder, and thus even when a tire component made of a metal member is disposed around the transponder, the phase of the back wave radiated from the transponder is not inverted when the back wave is reflected by the composite sheet. Thus, the front wave of the transponder and the back wave reflected by the composite sheet are adjusted to have the same phase or a small phase shift. This causes the front wave of the transponder and the back wave reflected by the composite sheet to act to intensify each other, allowing the communication performance of the transponder to be improved. Therefore, the communication distance of the transponder can be extended.

In the pneumatic tire according to an embodiment of the present technology, preferably, the composite sheet is disposed to have a longitudinal direction parallel with a longitudinal axis of the transponder, and a length ty of one pitch of a pattern formed by the conductor measured along the longitudinal axis of the transponder and a length tx of one pitch of the pattern formed by the conductor measured along a direction orthogonal to the longitudinal axis of the transponder satisfy a relationship 2.5≤ty/tx≤35.0. Thus, the communication performance of the transponder can be effectively improved.

Preferably, the composite sheet has a thickness ranging from 15 μm to 1500 μm. This can effectively improve the communication performance of the transponder while ensuring the durability of the composite sheet.

A ratio of a projected area of the composite sheet in the tire width direction to a projected area of the transponder in the tire width direction preferably ranges from 1.0 to 170.0. This can effectively improve the communication performance of the transponder without degrading the tire durability.

The transponder is preferably disposed on the sidewall portion. This can sufficiently ensure the tire durability.

Preferably, the transponder is disposed on an outer side in the tire width direction from the tire component made of a metal member, and the composite sheet is disposed between the transponder and the tire component made of a metal member. This can effectively improve the communication performance of the transponder.

The composite sheet preferably constitutes a frequency selective surface and/or a capacitance grid. This can effectively improve the communication performance of the transponder.

The composite sheet is preferably configured to adjust a reflection phase of a radiated radio wave of the transponder reflected by the tire component made of a metal member with respect to a phase of the radiated radio wave within the range from −160° to +160°. This can effectively improve the communication performance of the transponder.

The relative dielectric constant of the dielectric constituting the composite sheet preferably ranges from 1.5 to 10.0. This can suppress reduction in the radio wave intensity of the composite sheet and effectively improve the communication performance of the transponder.

The dielectric constituting the composite sheet is preferably made of rubber or elastomer. This can enhance the adhesiveness with the peripheral rubber member adjacent to the composite sheet and sufficiently ensure the durability of the tire.

Preferably, a relative dielectric constant of a coating layer covering the transponder is lower than a relative dielectric constant of a peripheral rubber member adjacent to the coating layer, and a total thickness Gac of the coating layer and a maximum thickness Gar of the transponder satisfy the relationship 1.1≤Gac/Gar≤3.0. The transponder is sufficiently separated from the peripheral rubber member and enclosed by the coating layer having a low relative dielectric constant, allowing the communication performance of the transponder to be improved. Further, specifying the upper limit value of the total thickness Gac of the coating layer with respect to the maximum thickness Gar of the transponder can ensure sufficient durability of the tire.

Preferably, the transponder is covered with a coating layer formed of elastomer or rubber, and the coating layer has a relative dielectric constant of 7 or less. Accordingly, the transponder is protected by the coating layer, allowing the durability of the transponder to be improved and also ensuring radio wave transmittivity of the transponder to allow the communication performance of the transponder to be effectively improved.

The center of the transponder is preferably disposed 10 mm or more away from a splice portion of a tire component in the tire circumferential direction. This can effectively improve tire durability.

A metal reinforcing layer is disposed on the side of a bead filler constituting the bead portion, and the transponder is preferably disposed between a position of 15 mm outer side in the tire radial direction from an upper end of a bead core constituting the bead portion and an upper end of the metal reinforcing layer. This causes the transponder to be disposed in a region where the stress amplitude of the tire is small and thus can reduce damage to the transponder and the composite sheet. Additionally, the tire durability can be sufficiently ensured.

In the present technology, the rubber constituting each member has a relative dielectric constant from 860 MHz to 960 MHz (operation frequency band of the transponder) at ordinary temperature. In this regard, the ambient temperature is 23±2° C. and 60%±5% RH (relative humidity) in accordance with the standard conditions of the JIS (Japanese Industrial Standard). The relative dielectric constant of the rubber is measured after 24 hour treatment at 23° C. and 60% RH. The range of from 860 MHz to 960 MHz described above corresponds to currently allocated frequencies of the RFID in a UHF (ultra-high frequency) band, but in a case where the allocated frequencies are changed, the relative dielectric constant in the range of the allocated frequencies may be specified as described above.

### BRIEF DESCRIPTION OF DRAWINGS

FIG. 1 is a meridian cross-sectional view illustrating an example of a pneumatic tire according to an embodiment of the present technology.

FIG. 2 is a meridian cross-sectional view schematically illustrating the pneumatic tire of FIG. 1.

FIG. 3 is a perspective view illustrating a transponder that can be embedded in a pneumatic tire according to an embodiment of the present technology.

FIG. 4 is an explanatory diagram illustrating radiated radio waves of a transponder embedded in a pneumatic tire according to an embodiment of the present technology.

FIGS. 5A to 5C each illustrate a composite sheet disposed in the pneumatic tire of FIG. 1, FIGS. 5A and 5B are plan views, and FIG. 5C is a cross-sectional view taken in the direction of an arrow X-X of FIG. 5B.

FIGS. 6A to 6C are cross-sectional views each illustrating a transponder embedded in a pneumatic tire according to an embodiment of the present technology.

FIG. 7 is an enlarged meridian cross-sectional view illustrating a transponder embedded in the pneumatic tire of FIG. 1.

FIG. 8 is a cross-sectional view illustrating a transponder covered with a coating layer and embedded in a pneumatic tire.

FIG. 9 is an equator line cross-sectional view schematically illustrating the pneumatic tire of FIG. 1.

FIG. 10 is a meridian cross-sectional view illustrating a modified example of a pneumatic tire according to an embodiment of the present technology.

FIG. 11 is an explanatory diagram illustrating the position of a transponder in a tire radial direction in a test tire.

FIG. 12 is an explanatory diagram illustrating radiated radio waves of a transponder embedded in a known pneumatic tire.

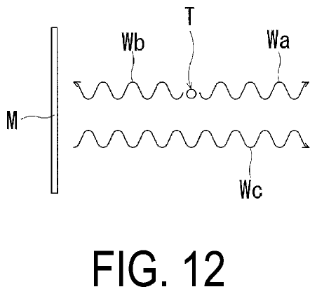

### DETAILED DESCRIPTION

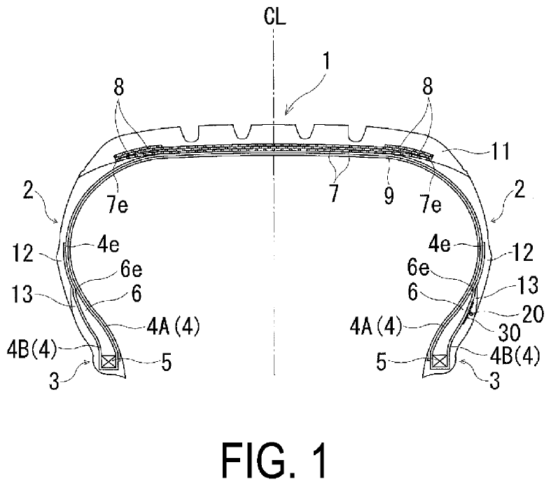

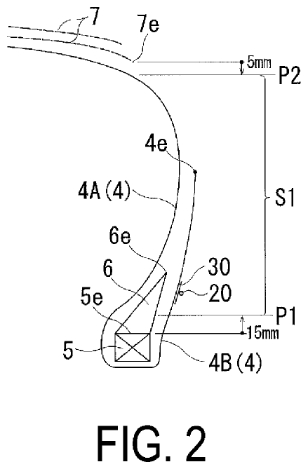

Configurations of embodiments of the present technology will be described in detail below with reference to the accompanying drawings. FIGS. 1 and 2 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on both sides of the tread portion 1, and a pair of bead portions 3 disposed on an inner side in a tire radial direction of the pair of sidewall portions 2.

At least one carcass layer 4 (one layer in FIG. 1) formed by arranging a plurality of carcass cords in the radial direction is mounted between the pair of bead portions 3. The carcass layer 4 is covered with rubber. Organic fiber cords such as nylon and polyester are preferably used as the carcass cord constituting the carcass layer 4. Bead cores 5 having an annular shape are embedded within the bead portions 3, and bead fillers 6 made of a rubber composition and having a triangular cross-section are disposed on the outer peripheries of the bead cores 5.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall within a range of from 10° to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from the tire inner side to the tire outer side around the bead cores 5 and are disposed wrapping around the bead cores 5 and the bead fillers 6. The carcass layer 4 includes a body portion 4A corresponding to a portion extending from the tread portion 1 through each of the sidewall portions 2 to each of the bead portions 3 and a turned-up portion 4B corresponding to a portion turned up around the bead core 5 at each of the bead portions 3 and extending toward each sidewall portion 2 side.

Additionally, on a tire inner surface, an innerliner layer 9 is disposed along the carcass layer 4. Furthermore, a cap tread rubber layer 11 is disposed in the tread portion 1, a sidewall rubber layer 12 is disposed in the sidewall portion 2, and a rim cushion rubber layer 13 is disposed in the bead portion 3.

A transponder 20 is embedded in the sidewall portion 2. More specifically, the transponder 20 is disposed between the carcass layer 4 and the sidewall rubber layer 12 or the rim cushion rubber layer 13 as a placement region in the tire width direction. Additionally, as an arrangement region in the tire radial direction, the transponder 20 is preferably disposed between a position P1 located on an outer side of and 15 mm away from an upper end 5e of the bead core 5 in the tire radial direction (end portion 5e on the outer side in the tire radial direction) and a position P2 located on an inner side of and 5 mm away from an end 7e of the belt layer 7 in the tire radial direction. In other words, the transponder 20 is preferably disposed in a region S1 illustrated in FIG. 2.

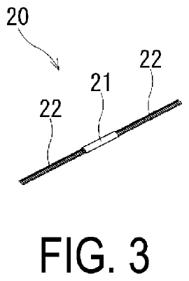

As the transponder 20, for example, a radio frequency identification (RFID) tag can be used. As illustrated in FIG. 3, the transponder 20 includes a substrate 21 that stores data and antennas 22 that transmit and receive data in a non-contact manner. By using the transponder 20 as described above to write or read information related to the tire on a timely basis, the tire can be efficiently managed. Note that “RFID” refers to an automatic recognition technology including: a reader/writer including an antenna and a controller; and an ID (identification) tag including a substrate and an antenna, the automatic recognition technology allowing data to be communicated in a wireless manner.

The overall shape of the transponder 20 is not limited to particular shapes, and for example, a transponder having a pillar-like shape can be used as illustrated in FIG. 3. Using the transponder 20 having a pillar-like shape is can suitably follow the deformation of the tire in each direction. In this case, the antennas 22 of the transponder 20 each project from both end portions of the substrate 21 and exhibit a helical shape. This allows the transponder 20 to follow the deformation of the tire during traveling, allowing the durability of the transponder 20 to be improved. Additionally, by appropriately changing the length of the antenna 22, the communication performance can be ensured.

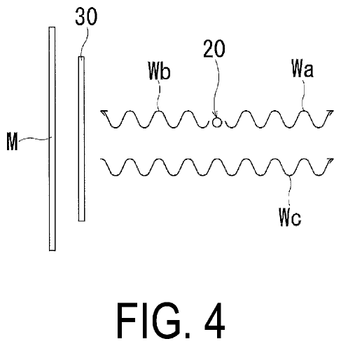

In the pneumatic tire described above, a composite sheet 30 that functions as an artificial magnetic conductor is disposed on the inner side in the tire width direction of the transponder 20. The artificial magnetic conductor typically has a function of adjusting the reflection phase of the electromagnetic waves inverted (rotated by 180°) on the conductor to the same phase. Accordingly, as illustrated in FIG. 4, when the back wave Wb of the transponder 20 is reflected by the composite sheet 30, the phase of the back wave Wb is not inverted. That is, the front wave Wa of the transponder 20 and the back wave Wc reflected by the composite sheet 30 are adjusted to have the same phase or a small phase shift. This causes the front wave Wa of the transponder 20 and the back wave Wc reflected by the composite sheet 30 to act to intensify each other. Even when the tire component M made of a metal member (for example, a chafer or a steel carcass) is disposed around the transponder 20, the similar effect can be obtained by disposing the composite sheet 30.

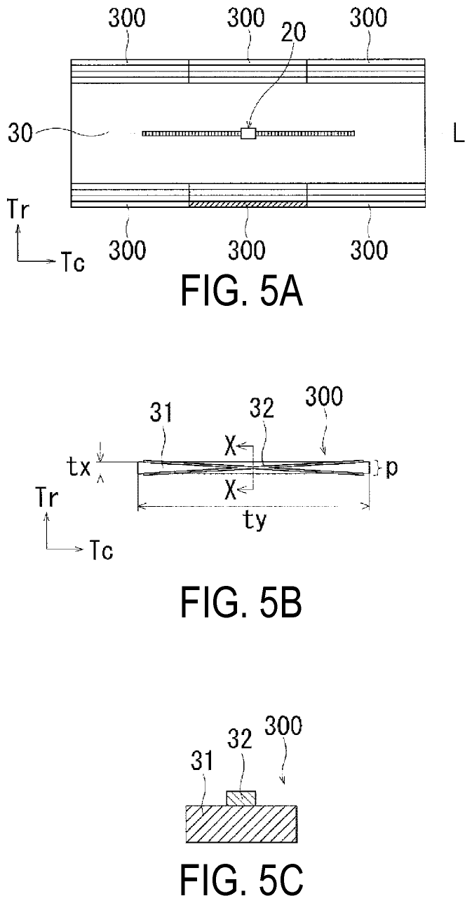

As illustrated in FIGS. 5A to 5C, such a composite sheet 30 includes a dielectric 31 forming a substrate and a conductor 32 periodically disposed on the dielectric 31. More specifically, the composite sheet 30 is composed of a plurality of elements 300 continuously arranged in each of the longitudinal direction and the lateral direction of the composite sheet 30, and in each of the elements 300 (hatched portion illustrated in FIG. 5A), the conductor 32 is fixed on the dielectric 31 to form a specific arrangement pattern. In the composite sheet 30, a pitch p illustrated in FIG. 5B is a repeating unit based on the pattern formed by the conductors 32. The arrangement pattern of the conductor 32 of the composite sheet 30 is not limited to a particular pattern, and any arrangement pattern can be appropriately employed. Note that, in FIG. 5A, the longitudinal direction of the composite sheet 30 and a longitudinal axis L of the transponder 20 are disposed parallel with a tire circumferential direction Tc, and the lateral direction of the composite sheet 30 is disposed parallel with a tire radial direction Tr.

The dielectric 31 of the composite sheet 30 can be made of a material having a low dielectric constant, such as an epoxy resin, a polyimide resin, a bismaleimide-triazine resin, a bismaleimide resin, or a phenol resin. Further, adding glass as a reinforcing fiber to the dielectric 31 can improve heat resistance. The dielectric 31 may be made of rubber or elastomer instead of resin, where the dielectric 31 may have flexibility. Further, when the dielectric 31 is made of rubber, it has tackiness and can be easily adhered to a peripheral rubber member adjacent to the dielectric 31, which is suitable from the viewpoint of handling performance. The conductor 32 can be fixed to the dielectric 31 by printing, vapor deposition, adhesion, or the like.

In the above-described pneumatic tire, the composite sheet 30 that includes the dielectric 31 forming a substrate and the conductor 32 periodically disposed on the dielectric 31 and functions as an artificial magnetic conductor is disposed on the inner side in the tire width direction of the transponder 20. The composite sheet 30 functioning as an artificial magnetic conductor is disposed on the inner side in the tire width direction of the transponder 20, and thus even when the tire component M made of a metal member is disposed around the transponder 20, the phase of the back wave Wb radiated from the transponder 20 is not inverted when the back wave Wb is reflected by the composite sheet 30. Accordingly, the front wave Wa of the transponder 20 and the back wave Wc reflected by the composite sheet 30 are adjusted to have the same phase or a small phase shift. This causes the front wave Wa of the transponder 20 and the back wave Wc reflected by the composite sheet 30 to act to intensify each other, allowing the communication performance of the transponder 20 to be improved. Therefore, the communication distance of the transponder 20 can also be extended.

In the pneumatic tire described above, the composite sheet 30 may be configured to form frequency selective surfaces or a capacitance grid, or may be configured to have a structure in which the frequency selective surfaces and the capacitance grid are combined. Further, the composite sheet 30 is preferably configured to adjust the reflection phase of the radiated radio wave of the transponder 20 reflected by the tire component M made of a metal member (for example, the back wave Wc illustrated in FIG. 4) with respect to the phase of the radiated radio wave (for example, the front wave Wa illustrated in FIG. 4) within a range from −160° to +160°, more preferably a range from −90° to +90°, and still more preferably a range from −45° to +45°. FIG. 4 illustrates an example in which the reflection phase of the back wave Wc with respect to the phase of the front wave Wa is 0°. Examples of such a tire component M made of a metal member include, for example, a belt layer, a reinforcing layer (chafer or the like), and a carcass layer formed of a steel cord used in a tire for a truck/bus. By constituting the composite sheet 30 as described above, the communication performance of the transponder 20 can be effectively improved. Note that, the frequency selective surfaces are spatial filters that transmit or reflect electromagnetic waves having specific frequencies.

As illustrated in FIG. 4, preferably, the transponder 20 is disposed on the outer side in the tire width direction from the tire component M formed of a metal member, and the composite sheet 30 is disposed between the transponder and the tire component M made of a metal member. When the composite sheet 30 functioning as an artificial magnetic conductor is used, it is not necessary to sufficiently separate the transponder 20 from the tire component M made of a metal member in order to avoid degradation of the communication performance of the transponder 20, and thus the transponder 20 can be disposed at a position close to the tire component M made of a metal member. Disposing the transponder 20 and the composite sheet 30 as described above can effectively improve the communication performance of the transponder 20.

On the other hand, when the composite sheet 30 according to an embodiment of the present technology is not used, the communication performance of the transponder is degraded, and thus it is difficult to dispose the transponder at a position close to the tire component made of a metal member. It is necessary to sufficiently separate the transponder from the tire component made of a metal member so as to ensure predetermined communication performance when the transponder is disposed.

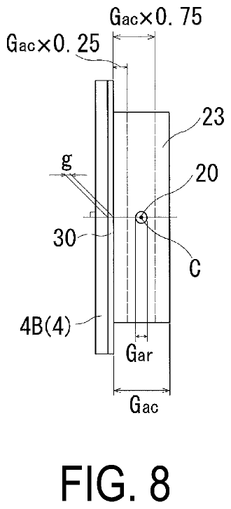

Additionally, in the pneumatic tire described above, a thickness g of the composite sheet 30 (see FIG. 8, for example) preferably ranges from 15 μm to 1500 μm. By properly setting the thickness g of the composite sheet 30 as described above, the communication performance of the transponder 20 can be effectively improved while ensuring the durability of the composite sheet 30. Note that, the thickness g of the composite sheet 30 is the total thickness of the composite sheet 30 at a position including the transponder 20. As illustrated in FIG. 8, for example, the thickness g is the total thickness on a straight line that is orthogonal to a carcass cord of the closest carcass layer 4 and passes through the center C of the transponder 20 in the tire meridian cross-section.

Here, when the thickness g of the composite sheet 30 is less than 15 μm, the communication performance of the transponder 20 tends to degrade, and also the handling performance of the composite sheet 30 degrades, and the tire production capacity degrades (the cycle time when forming the tire increases). In contrast, when the thickness g of the composite sheet 30 is larger than 1500 μm, the composite sheet 30 is less likely to follow the deformation of the tire, and the dielectric 31 may be broken or damaged to fail to function.

The ratio of the projected area of the composite sheet 30 in the tire width direction to the projected area of the transponder 20 in the tire width direction preferably ranges from 1.0 to 170.0, more preferably ranges from 6.0 to 120.0, still more preferably ranges from 10.0 to 80.0, and most preferably ranges from 20.0 to 80.0. At this time, the projected area of the composite sheet in the tire width direction preferably ranges from 400 mm² to 4320 mm², more preferably ranges from 600 mm² to 3000 mm², and most preferably ranges from 1000 mm² to 3000 mm². By properly setting the ratio of the projected area of the composite sheet 30 to the projected area of the transponder 20 as described above, the tire durability is not degraded, and the communication performance of the transponder 20 can be effectively improved.

Here, when the above-described ratio is smaller than 1.0 (when the projected area of the composite sheet 30 is excessively small), the effect of improving the communication performance of the transponder 20 cannot be sufficiently obtained. In contrast, when the above-described ratio is larger than 170.0 (when the projected area of the composite sheet 30 is excessively large), separation occurs with peripheral rubber members (for example, the coating rubber of the carcass layer 4, the sidewall rubber layer 12, and the rim cushion rubber layer 13) adjacent to the composite sheet 30, and the tire durability tends to degrade.

Furthermore, in the pneumatic tire described above, the relative dielectric constant of the dielectric 31 constituting the composite sheet 30 preferably ranges from 1.5 to 10.0. By properly setting the relative dielectric constant of the dielectric 31 as described above, reduction in the radio wave intensity of the composite sheet 30 is suppressed, and the communication performance of the transponder 20 can be effectively improved. Here, when the relative dielectric constant of the dielectric 31 is larger than 10.0, the effect of improving the communication performance of the transponder 20 cannot be sufficiently obtained.

Additionally, the dielectric 31 constituting the composite sheet 30 is preferably made of rubber or elastomer. Configuring the dielectric 31 as described above can enhance adhesiveness with the peripheral rubber member adjacent to the composite sheet 30, and the tire durability can be sufficiently ensured.

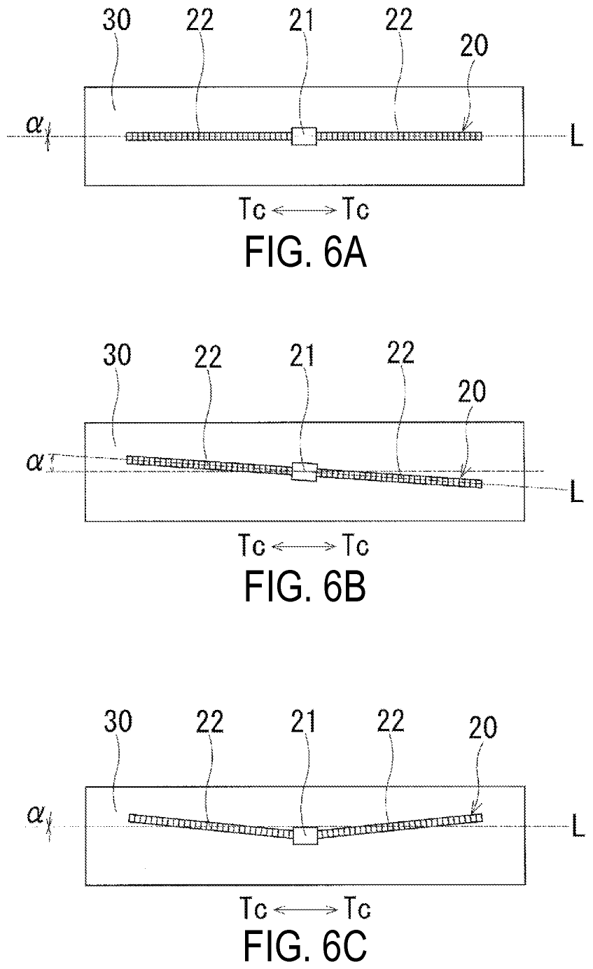

As illustrated in FIGS. 6A to 6C, the longitudinal direction of the composite sheet 30 is preferably disposed so as to be parallel with the longitudinal axis L of the transponder 20. At this time, the longitudinal direction of the composite sheet 30 may be inclined within the range from −5° to +5° with respect to the longitudinal axis L of the transponder 20. In FIGS. 6A to 6C, the longitudinal direction of the composite sheet 30 is disposed to be parallel with the tire circumferential direction Tc, and thus an inclination angle α of the longitudinal axis L of the transponder 20 with respect to the tire circumferential direction Tc may range from −5° to +5°. In the case of the pillar-like transponder 20, the extension direction of the antenna 22 is an electric field component direction, and thus when the composite sheet 30 is disposed as described above, the longitudinal direction of the composite sheet is disposed to be parallel with the electric field component direction of the transponder 20, and the lateral direction of the composite sheet 30 is disposed along a direction orthogonal to the electric field component direction of the transponder 20. Note that, the longitudinal axis L of the transponder 20 is basically a straight line passing through the center of the substrate 21 and connecting both ends of the antenna 22 (see FIGS. 6A and 6B), but when the transponder 20 is bent or curved due to the curvature of the tire or the like, the longitudinal axis L is a straight line having the same distance from three points, the center of the substrate 21 and both ends of the antenna 22 (see FIG. 6C).

With the composite sheet 30 disposed to have a longitudinal direction parallel with the longitudinal axis L of the transponder 20 as described above, the length ty of one pitch of the pattern formed by the conductor 32 of the composite sheet 30 and the length tx of one pitch of the pattern formed by the conductor 32 of the composite sheet 30 preferably satisfy the relationship 2.5≤ty/tx≤35.0. Note that the length ty is measured along the longitudinal axis L of the transponder 20 and the length tx is measured along a direction orthogonal to the longitudinal axis L of the transponder 20.

As described above, the composite sheet 30 is disposed such that the longitudinal direction thereof is parallel with the longitudinal axis of the transponder 20 and the length ty and the length tx satisfy the relationship 2.5≤ty/tx≤35.0, and thus the communication performance of the transponder 20 can be effectively improved. Here, when the length ty and the length tx are out of the above-described range of the relationship formula, the effect of improving the communication performance of the transponder 20 cannot be sufficiently obtained.

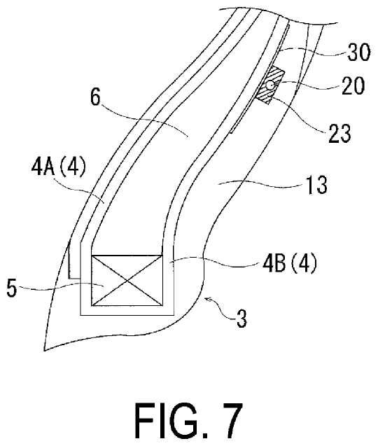

As illustrated in FIG. 7, the transponder 20 is preferably covered with a coating layer 23 made of elastomer or rubber. The coating layer 23 coats the entire transponder 20 while holding both front and rear sides of the transponder 20. The coating layer 23 may be formed from rubber having physical properties identical to those of the rubber constituting the sidewall rubber layer 12 or the rim cushion rubber layer 13 or from rubber having different physical properties. The transponder 20 is protected by the coating layer 23 as described above, and thus the durability of the transponder 20 can be improved. Note that the cross-sectional shape of the coating layer 23 is not limited to particular shapes and can adopt, for example, a triangular shape, a rectangular shape, a trapezoidal shape, and a spindle shape.

As the composition of the coating layer 23, the coating layer 23 is preferably made of rubber or elastomer and 20 phr or more of white filler. The relative dielectric constant can be set relatively lower for the coating layer 23 configured as described above than for the coating layer 23 containing carbon, allowing the communication performance of the transponder 20 to be effectively improved. Note that “phr” as used herein means parts by weight per 100 parts by weight of the rubber component (elastomer).

The white filler constituting the coating layer 23 preferably includes from 20 phr to 55 phr of calcium carbonate. This enables a relatively low relative dielectric constant to be set for the coating layer 23, allowing the communication performance of the transponder 20 to be effectively improved. However, the white filler with an excessive amount of calcium carbonate contained is brittle, and the strength of the coating layer 23 decreases. This is not preferable. Additionally, the coating layer 23 can optionally contain, in addition to calcium carbonate, 20 phr or less of silica (white filler) or 5 phr or less of carbon black. In a case where a small amount of silica or carbon black is used with the coating layer 23, the relative dielectric constant of the coating layer 23 can be reduced while ensuring the strength of the coating layer 23.

In addition, the coating layer 23 preferably has a relative dielectric constant of 7 or less, and more preferably from 2 to 5. By properly setting the relative dielectric constant of the coating layer 23 as described above, radio wave transmittivity can be ensured during emission of a radio wave by the transponder 20, effectively improving the communication performance of the transponder 20.

In the pneumatic tire described above, preferably, the relative dielectric constant of the coating layer 23 covering the transponder 20 is lower than the relative dielectric constant of the peripheral rubber member (for example, the coating rubber of the carcass layer 4, the bead filler 6, the cap tread rubber layer 11, the sidewall rubber layer 12, or the rim cushion rubber layer 13) adjacent to the coating layer 23, and the total thickness Gac of the coating layer 23 and the maximum thickness Gar of the transponder 20 preferably satisfy the relationship 1.1≤Gac/Gar≤3.0. The total thickness Gac of the coating layer 23 is the total thickness of the coating layer 23 at a position including the transponder 20, and is, for example, as illustrated in FIG. 8, the total thickness on a straight line passing through the center C of the transponder 20 and orthogonal to the carcass cord of the closest carcass layer 4 in a tire meridian cross-section.

As described above, appropriately setting the ratio of the total thickness Gac of the coating layer 23 to the maximum thickness Gar of the transponder can sufficiently ensure the communication distance of the transponder 20. Here, when the above-described ratio is excessively small (the total thickness Gac of the coating layer 23 is excessively thin), the transponder 20 comes into contact with an adjacent rubber member, resonant frequency is shifted, and the communication performance of the transponder 20 is degraded. On the other hand, when the above-described ratio is excessively large (the total thickness Gac of the coating layer 23 is excessively thick), the tire durability tends to be degraded.

As illustrated in FIG. 8, in the pneumatic tire described above, the center C of the transponder 20 in a thickness direction is preferably disposed within a range from 25% to 75% of the total thickness Gac of the coating layer 23 from a surface on one side of the coating layer 23 in a thickness direction. Accordingly, the transponder 20 is securely covered with the coating layer 23, and thus the surrounding environment of the transponder 20 becomes stable and the communication distance of the transponder 20 can be sufficiently ensured without causing the shifting of the resonant frequency.

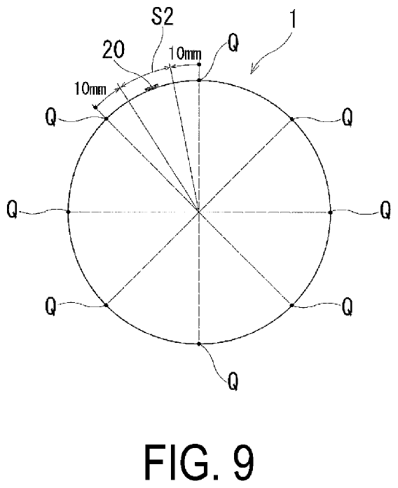

As illustrated in FIG. 9, a plurality of splice portions formed by overlaying end portions of the tire component are on the tire circumference. FIG. 9 illustrates positions Q of the respective splice portions in the tire circumferential direction. The center of the transponder 20 is preferably disposed 10 mm or more away from the splice portion of the tire component in the tire circumferential direction. In other words, the transponder 20 is preferably disposed in a region S2 illustrated in FIG. 9. Specifically, the substrate 21 constituting the transponder 20 is preferably located 10 mm or more away from the position Q in the tire circumferential direction. Furthermore, the entire transponder 20 including the antenna 22 is more preferably located 10 mm or more away from the position Q in the tire circumferential direction, and the entire transponder 20 covered with the coating rubber is most preferably located 10 mm or more away from the position Q in the tire circumferential direction. In addition, the tire component in which the splice portion is disposed away from the transponder 20 is preferably a member adjacent to the transponder 20. Examples of such a tire component include the carcass layer 4, the bead filler 6, the belt layer 7, the cap tread rubber layer 11, the sidewall rubber layer 12, the rim cushion rubber layer 13, and the reinforcing layer (for example, chafer). Disposing the transponder 20 away from the splice portions of the tire component as described above can effectively improve tire durability.

Note that in the embodiment of FIG. 9, an example in which the positions Q of the splice portions of each tire component in the tire circumferential direction are disposed at equal intervals, but no such limitation is intended. The position Q in the tire circumferential direction can be set at any position, and in either case, the transponder 20 is disposed 10 mm or more away from the splice portion of each tire component in the tire circumferential direction. In addition, in the embodiment of FIG. 9, the splice portion can be configured such that both end portions of the tire component in the tire circumferential direction overlap each other, where both end portions in the tire circumferential direction cut so as to be inclined with respect to the tire width direction may overlap each other. Alternatively, the splice portion may be configured such that both end portions of the tire component in the tire circumferential direction abut against each other.

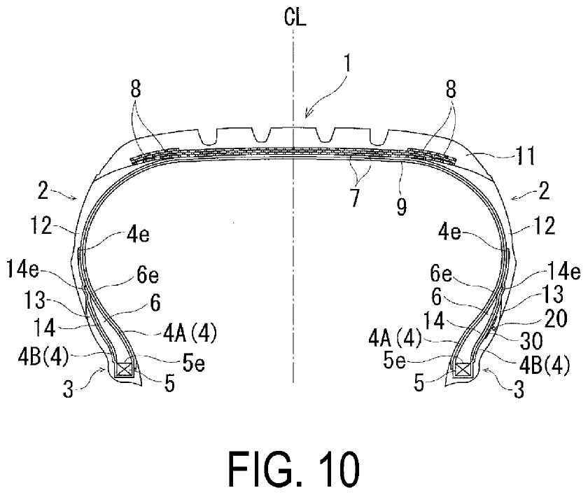

FIG. 10 illustrates a modified example of a pneumatic tire according to an embodiment of the present technology. In FIG. 10, components that are identical to those in FIGS. 1 to 9 have the same reference signs, and detailed descriptions of those components have been omitted.

As illustrated in FIG. 10, in order to reinforce the bead portion 3, a metal reinforcing layer 14 is disposed adjacent to the bead filler 6 on an outer side in the tire width direction of the bead filler 6. In FIG. 10, an upper end 14e of the metal reinforcing layer 14 is disposed higher than an upper end 6e of the bead filler 6. In particular, the upper end 14e of the metal reinforcing layer 14 is preferably disposed on the outer side in the tire radial direction by 5 mm or more away from the upper end 6e of the bead filler 6, and more preferably disposed on the outer side in the tire radial direction by 10 mm or more away from the upper end 6e of the bead filler 6. Further, the metal reinforcing layer 14 is formed by embedding a plurality of steel cords in rubber.

In the pneumatic tire described above, the transponder 20 is disposed between the position P1 located on the outer side of and 15 mm away from the upper end 5e of the bead core 5 in the tire radial direction and the upper end 14e of metal reinforcing layer 14. By disposing the transponder 20 as described above, the transponder 20 is disposed in a region where the stress amplitude of the tire is small, and thus damage to the transponder 20 and the composite sheet can be suppressed. Additionally, the tire durability can be sufficiently ensured. Here, when the transponder 20 is disposed on the inner side from the position P1 in the tire radial direction, it is not preferable that separation between the transponder 20 and the adjacent rubber member easily occurs due to stress concentration in the vicinity of the rim flange portion.

In the above description, an example of a pneumatic tire including the carcass layer 4 formed of organic fiber cords is illustrated as a tire for a passenger vehicle. However, no such limitation is intended. The present technology can also be applied to a tire for a truck/bus, where it is preferable to use the carcass layer 4 formed of steel cords. Further, the number of the carcass layers 4 is not limited to the particular number and may be two or more. Furthermore, the disposition of the metal reinforcing layer 14 is not limited to a particular disposition. Although and an example in which the metal reinforcing layer 14 is disposed adjacent to the bead filler 6 on the outer side in the tire width direction of the bead filler 6 is described, the metal reinforcing layer 14 may be disposed not adjacent to the bead filler 6 on the outer side in the tire width direction of the bead filler 6 or may be disposed adjacent to the bead filler 6 on the inner side in the tire width direction of the bead filler 6. In any case described above, the transponder 20 is disposed on the outer side in the tire width direction from the tire component formed from a metal member (the carcass layer 4 formed of steel cords or the metal reinforcing layer 14). Further, the transponder 20 is preferably disposed on the outer side in the tire width direction of the carcass layer 4.

Additionally, although an example where the transponder 20 is embedded in the sidewall portion 2 has been described, the transponder 20 may be embedded in the tread portion 1 (for example, an upper region of the belt layer 7).

### Example

Pneumatic tires according to Conventional Examples and Examples 1 to 22 were manufactured. The pneumatic tires have a tire size of 235/60R18 and include a tread portion extending in the tire circumferential direction and having an annular shape, a pair of sidewall portions respectively disposed on both sides of the tread portion, a pair of bead portions each disposed on an inner side of the pair of sidewall portions in the tire radial direction, and a transponder embedded. In the pneumatic tires, the position of the transponder (tire radial direction and tire circumferential direction), a composite sheet (presence, ty/tx, thickness, ratio of projected area, relative dielectric constant of the dielectric and constituent material of the dielectric), a metal reinforcing layer (presence), a coating layer (constituent material, relative dielectric constant, and Gac/Gar) are set as shown in Tables 1 and 2.

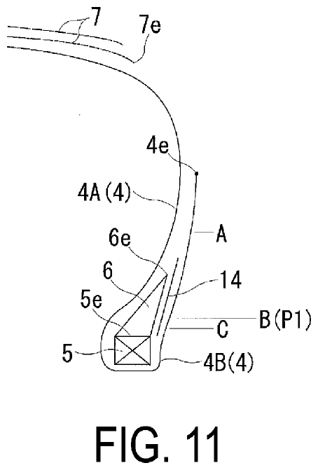

Note that, in Tables 1 and 2, the position of the transponder (in the tire radial direction) corresponds to each of the positions A to C illustrated in FIG. 11. The position of the transponder (tire circumferential direction) indicates the distance (mm) measured from the center of the transponder to the splice portion of the tire component in the tire circumferential direction. In Tables 1 and 2, the ratio of the projected area means the ratio of the projected area of the composite sheet in the tire width direction to the projected area of the transponder in the tire width direction.

In Conventional Example and Examples 1 to 22, the transponder is disposed between the carcass layer and the sidewall rubber layer or the rim cushion rubber layer, and the metal reinforcing layer is disposed adjacent to the bead filler on the outer side in the tire width direction of the bead filler. In Examples 1 to 22, the composite sheet is disposed on the inner side in the tire width direction of the transponder, and the conductor of the composite sheet constitutes the frequency selective surface.

Transponder evaluation (communication performance), composite sheet evaluation (durability), and tire evaluation (durability) were conducted on the test tires using a test method described below, and the results are indicated in Tables 1 and 2.

Communication Performance (Transponder):

For each test tire, a communication operation with the transponder was performed using a reader/writer. Specifically, the maximum communication distance was measured with the reader/writer at a power output of 250 mW and a carrier frequency of from 860 MHz to 960 MHz. The evaluation results are expressed in three levels: “Excellent” indicates that the communication distance is 1000 mm or more, “Good” indicates that the communication distance is 500 mm or more and less than 1000 mm, and “Fair” indicates that the communication distance is less than 500 mm.

Durability (Composite Sheet and Tire):

Each of the test tires was mounted on a wheel of a standard rim, and a traveling test was performed by using a drum testing machine at an air pressure of 120 kPa, a maximum load of 102%, and a traveling speed of 81 km/h, and the traveling distance at the time of a failure in the tire was measured. Evaluation results are expressed in three levels: “Excellent” indicating that the traveling distance reached 6480 km, “Good” indicating that the traveling distance was 4050 km or more and less than 6480 km, and “Fair” indicating that the traveling distance was less than 4050 km. Further, after completion of the travel above, the communication distance of the composite sheet embedded in each test tire was measured to evaluate the durability of the composite sheet. Evaluation results are expressed in three levels: “Excellent” indicating that the composite sheet is equivalent to the new product, “Good” indicating that the composite sheet functions normally although the communication distance is shorter than the new product, and “Poor” indicating that the composite sheet is damaged and does not function.

TABLE 1-1

| | | Conventional | Example | Example | Example |
|---|---|---|---|---|---|
| | | Example | 1 | 2 | 3 |
| Position of | Tire radial direction | A | A | A | A |
| transponder | Tire circumferential | 10 | 10 | 10 | 10 |
| | direction (mm) | | | | |
| Composite sheet | Presence | No | Yes | Yes | Yes |
| | ty/tx | — | 2.0 | 2.5 | 35.0 |
| | Thickness (μm) | — | 100 | 100 | 100 |
| | Ratio of projected | — | 10.0 | 10.0 | 10.0 |
| | area | | | | |
| | Relative dielectric | — | 1.5 | 1.5 | 1.5 |
| | constant of | | | | |
| | dielectric | | | | |
| | Constituent | — | Resin | Resin | Resin |
| | material of | | | | |
| | dielectric | | | | |
| Metal | Presence | Yes | Yes | Yes | Yes |
| reinforcing layer | | | | | |
| Coating layer | Constituent | — | — | — | — |
| | material | | | | |
| | Relative dielectric | — | — | — | — |
| | constant | | | | |
| | Gac/Gar | — | — | — | — |
| Transponder | Communication | Fair | Good | Excellent | Excellent |
| evaluation | performance | | | | |
| Composite sheet | Durability | — | Good | Good | Good |
| evaluation | | | | | |
| Tire evaluation | Durability | Good | Good | Good | Good |

TABLE 1-2

| | | Example | Example | Example | Example |
|---|---|---|---|---|---|
| | | 4 | 5 | 6 | 7 |
| Position of | Tire radial direction | A | A | A | A |
| transponder | Tire circumferential | 10 | 10 | 10 | 10 |
| | direction (mm) | | | | |
| Composite | Presence | Yes | Yes | Yes | Yes |
| sheet | ty/tx | 2.5 | 2.5 | 2.5 | 2.5 |
| | Thickness (μm) | 15 | 1500 | 1600 | 100 |
| | Ratio of projected | 10.0 | 10.0 | 10.0 | 1.0 |
| | area | | | | |
| | Relative dielectric | 1.5 | 1.5 | 1.5 | 1.5 |
| | constant of dielectric | | | | |
| | Constituent material | Resin | Resin | Resin | Resin |
| | of dielectric | | | | |
| Metal | Presence | Yes | Yes | Yes | Yes |
| reinforcing | | | | | |
| layer | | | | | |
| Coating layer | Constituent material | — | — | — | — |
| | Relative dielectric | — | — | — | — |
| | constant | | | | |
| | Gac/Gar | — | — | — | — |
| Transponder | Communication | Excellent | Excellent | Excellent | Excellent |
| evaluation | performance | | | | |
| Composite | Durability | Good | Good | Poor | Good |
| sheet | | | | | |
| evaluation | | | | | |
| Tire | Durability | Good | Good | Good | Excellent |
| evaluation | | | | | |

TABLE 1-3

| | | Example | Example | Example | Example |
|---|---|---|---|---|---|
| | | 8 | 9 | 10 | 11 |
| Position of | Tire radial direction | A | A | A | A |
| transponder | Tire circumferential | 10 | 10 | 10 | 10 |
| | direction (mm) | | | | |
| Composite | Presence | Yes | Yes | Yes | Yes |
| sheet | ty/tx | 2.5 | 2.5 | 2.5 | 2.5 |
| | Thickness (μm) | 100 | 100 | 100 | 100 |
| | Ratio of projected | 170.0 | 10.0 | 10.0 | 10.0 |
| | area | | | | |
| | Relative dielectric | 1.5 | 10.0 | 11.0 | 1.5 |
| | constant of dielectric | | | | |
| | Constituent material | Resin | Resin | Resin | Rubber |
| | of dielectric | | | | |
| Metal | Presence | Yes | Yes | Yes | Yes |
| reinforcing | | | | | |
| layer | | | | | |
| Coating layer | Constituent material | — | — | — | — |
| | Relative dielectric | — | — | — | — |
| | constant | | | | |
| | Gac/Gar | — | — | — | — |
| Transponder | Communication | Excellent | Excellent | Good | Excellent |
| evaluation | performance | | | | |
| Composite | Durability | Good | Good | Good | Good |
| sheet | | | | | |
| evaluation | | | | | |
| Tire | Durability | Good | Good | Good | Excellent |
| evaluation | | | | | |

TABLE 2-1

| | | Example | Example | Example | Example |
|---|---|---|---|---|---|
| | | 12 | 13 | 14 | 15 |
| Position of | Tire radial direction | A | B | C | B |
| transponder | Tire circumferential | 5 | 10 | 10 | 10 |
| | direction (mm) | | | | |
| Composite | Presence | Yes | Yes | Yes | Yes |
| sheet | ty/tx | 2.5 | 2.5 | 2.5 | 2.5 |
| | Thickness (μm) | 100 | 100 | 100 | 100 |
| | Ratio of projected | 10.0 | 10.0 | 10.0 | 10.0 |
| | area | | | | |
| | Relative dielectric | 1.5 | 1.5 | 1.5 | 1.5 |
| | constant of dielectric | | | | |
| | Constituent material | Rubber | Rubber | Rubber | Rubber |
| | of dielectric | | | | |
| Metal | Presence | Yes | Yes | Yes | Yes |
| reinforcing | | | | | |
| layer | | | | | |
| Coating layer | Constituent material | — | — | — | Resin |
| | Relative dielectric | — | — | — | 7 |
| | constant | | | | |
| | Gac/Gar | — | — | — | 2.0 |
| Transponder | Communication | Excellent | Excellent | Good | Excellent |
| evaluation | performance | | | | |
| Composite | Durability | Good | Excellent | Good | Excellent |
| sheet | | | | | |
| evaluation | | | | | |
| Tire | Durability | Good | Excellent | Good | Good |
| evaluation | | | | | |

TABLE 2-2

| | | Example | Example | Example | Example |
|---|---|---|---|---|---|
| | | 16 | 17 | 18 | 19 |
| Position of | Tire radial direction | B | B | B | B |
| transponder | Tire circumferential | 10 | 10 | 10 | 10 |
| | direction (mm) | | | | |
| Composite | Presence | Yes | Yes | Yes | Yes |
| sheet | ty/tx | 2.5 | 2.5 | 2.5 | 2.5 |
| | Thickness (μm) | 100 | 100 | 100 | 100 |
| | Ratio of projected | 10.0 | 10.0 | 10.0 | 10.0 |
| | area | | | | |
| | Relative dielectric | 1.5 | 1.5 | 1.5 | 1.5 |
| | constant of dielectric | | | | |
| | Constituent material | Rubber | Rubber | Rubber | Rubber |
| | of dielectric | | | | |
| Metal | Presence | Yes | Yes | Yes | Yes |
| reinforcing | | | | | |
| layer | | | | | |
| Coating layer | Constituent material | Rubber | Rubber | Rubber | Rubber |
| | Relative dielectric | 3.5 | 7 | 8 | 7 |
| | constant | | | | |
| | Gac/Gar | 2.0 | 2.0 | 2.0 | 1.0 |
| Transponder | Communication | Excellent | Excellent | Good | Good |
| evaluation | performance | | | | |
| Composite | Durability | Excellent | Excellent | Excellent | Excellent |
| sheet | | | | | |
| evaluation | | | | | |
| Tire | Durability | Excellent | Excellent | Excellent | Excellent |
| evaluation | | | | | |

TABLE 2-3

| | | Example | Example | Example |
|---|---|---|---|---|
| | | 20 | 21 | 22 |
| Position of transponder | Tire radial direction | B | B | B |
| | Tire circumferential | 10 | 10 | 10 |
| | direction (mm) | | | |
| Composite sheet | Presence | Yes | Yes | Yes |
| | ty/tx | 2.5 | 2.5 | 2.5 |
| | Thickness (μm) | 100 | 100 | 100 |
| | Ratio of projected | 10.0 | 10.0 | 10.0 |
| | area | | | |
| | Relative dielectric | 1.5 | 1.5 | 1.5 |
| | constant of dielectric | | | |
| | Constituent material | Rubber | Rubber | Rubber |
| | of dielectric | | | |
| Metal reinforcing layer | Presence | Yes | Yes | Yes |
| Coating layer | Constituent material | Rubber | Rubber | Rubber |
| | Relative dielectric | 7 | 7 | 7 |
| | constant | | | |
| | Gac/Gar | 1.1 | 3.0 | 3.1 |
| Transponder evaluation | Communication | Excellent | Excellent | Good |
| | performance | | | |
| Composite sheet | Durability | Excellent | Excellent | Excellent |
| evaluation | | | | |
| Tire evaluation | Durability | Excellent | Excellent | Good |

As can be seen from Tables 1 and 2, in Examples 1 to 22, the communication performance of the transponder, the durability of the composite sheet and the tire were improved in a well-balanced manner.

1-14. (canceled)

15. A pneumatic tire, comprising:
a tread portion extending in a tire circumferential direction and having an annular shape;
a pair of sidewall portions respectively disposed on both sides of the tread portion;
a pair of bead portions each disposed on an inner side of the pair of sidewall portions in a tire radial direction; and
a transponder embedded;
a composite sheet that comprises a dielectric forming a substrate and a conductor periodically disposed on the dielectric and functions as an artificial magnetic conductor being disposed on an inner side in a tire width direction of the transponder.

16. The pneumatic tire according to claim 15, wherein the composite sheet is disposed to have a longitudinal direction of parallel with a longitudinal axis of the transponder, and a length ty of one pitch of a pattern formed by the conductor measured along the longitudinal axis of the transponder and a length tx of one pitch of the pattern formed by the conductor measured along a direction orthogonal to the longitudinal axis of the transponder satisfy a relationship 2.5≤ty/tx≤35.0.

17. The pneumatic tire according to claim 15, wherein the composite sheet has a thickness ranging from 15 μm to 1500 μm.

18. The pneumatic tire according to claim 15, a ratio of a projected area of the composite sheet in the tire width direction to a projected area of the transponder in the tire width direction ranges from 1.0 to 170.0.

19. The pneumatic tire according to claim 15, wherein the transponder is disposed in a sidewall portion of the sidewall portions.

20. The pneumatic tire according to claim 15, wherein the transponder is disposed on an outer side in the tire width direction from a tire component made of a metal member, and the composite sheet is disposed between the transponder and the tire component made of a metal member.

21. The pneumatic tire according to claim 15, wherein the composite sheet constitutes a frequency selective surface and/or a capacitance grid.

22. The pneumatic tire according to claim 15, wherein the composite sheet is configured to adjust a reflection phase of a radiated radio wave of the transponder reflected by a tire component made of a metal member with respect to a phase of the radiated radio wave within a range from −160° to +160°.

23. The pneumatic tire according to claim 15, wherein a relative dielectric constant of a dielectric constituting the composite sheet ranges from 1.5 to 10.0.

24. The pneumatic tire according to claim 15, wherein the dielectric constituting the composite sheet is made of rubber or elastomer.

25. The pneumatic tire according to claim 15, wherein
a relative dielectric constant of a coating layer covering the transponder is lower than a relative dielectric constant of a peripheral rubber member adjacent to the coating layer, and
a total thickness Gac of the coating layer and a maximum thickness Gar of the transponder satisfy a relationship 1.1≤Gac/Gar≤3.0.

26. The pneumatic tire according to claim 15, wherein
the transponder is covered with a coating layer made of elastomer or rubber, and
the coating layer has a relative dielectric constant of 7 or less.

27. The pneumatic tire according to claim 15, wherein a center of the transponder is disposed 10 mm or more away in the tire circumferential direction from a splice portion of a tire component.

28. The pneumatic tire according to claim 15, wherein a metal reinforcing layer is disposed on a side of a bead filler constituting a bead portion of the bead portions, and the transponder is disposed between a position of 15 mm outer side in the tire radial direction from an upper end of a bead core constituting the bead portion and an upper end of the metal reinforcing layer.
